(19) United States
(12) Patent Application Publication
(10) Pub. No.: US 2012/0159257 A1
(43) Pub. Date: Jun. 21, 2012

(54) CONTROL COMPUTER AND REPORT MANAGEMENT METHOD USING THE SAME

(75) Inventor: YI-TSANG CHEN, Tu-Cheng (TW)

(73) Assignee: HON HAI PRECISION INDUSTRY CO., LTD., Tu-Cheng (TW)

(21) Appl. No.: 13/175,958

(22) Filed: Jul. 5, 2011

(30) Foreign Application Priority Data
Dec. 15, 2010 (TW) 99143888

(51) Int. Cl. G06F 11/07

(52) U.S. Cl. 714/37; 714/E11.029

(57) ABSTRACT

A method for managing test reports of a system under test (SUT) using a control computer obtains an initial test report of the SUT, adds error logs of the initial test report in a defect library of a storage device of the control computer, and adds error causes and solutions corresponding to the error logs in a root cause library and a solution library of the storage device respectively. The method further adds the error causes and the solutions corresponding to the error logs in the initial test report, to generate an optimized report of the SUT.

### BACKGROUND

1. Technical Field

Embodiments of the present disclosure relate to test technology, and more particularly to a control computer and method for managing test reports of a system under test (SUT) using the control computer.

2. Description of Related Art

Test reports of a system under test (SUT) need to be manually adjusted when the test report is created using an analyzer connected with the SUT. For example, a user needs to check to see if the test report contains an error log, and add a cause of error statement and propose a solution corresponding to found error log in the test report, to optimize the value of the test report. However, the above mentioned manual method is not expedient and is inefficient. Therefore, a more efficient method for managing the test reports of the system under test is desired.

### BRIEF DESCRIPTION OF THE DRAWINGS

FIG. 1 is a schematic diagram of one embodiment of a control computer in communication with an analyzer through a switch.

FIG. 2 is a block diagram of one embodiment of the control computer.

FIG. 3 is a block diagram of one embodiment of a report management system in the control computer.

FIG. 4 is a flowchart of one embodiment of a method for managing the test reports of a system under test (SUT) using the control computer.

FIG. 5 is another description of the flowchart of FIG. 4.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

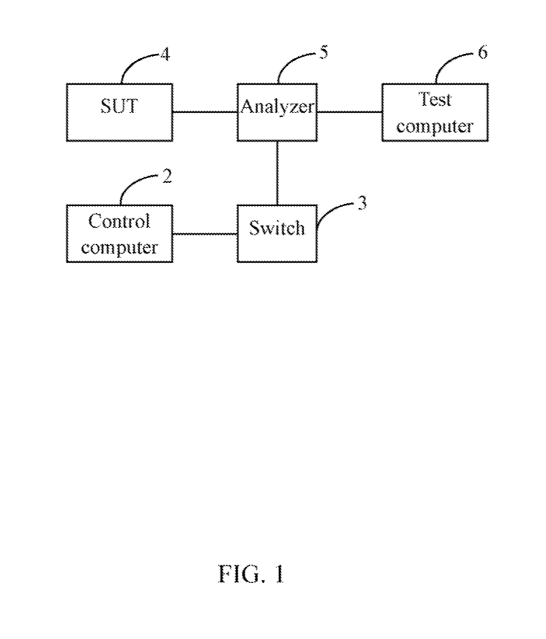

FIG. 1 is a schematic diagram of one embodiment of a control computer 2 in communication with an analyzer 5 through a switch 3. Furthermore, the analyzer 5 is connected to a system under test (SUT) 4 and a test computer 6 through data cable. The data cable may be a serial attached SCSI (SAS) cable, a fibre channel (FC) cable, or any other suitable cable. In one embodiment, the SUT 4 may be a storage system, the analyzer 5 may be a serial protocol analyzer.

In one embodiment, the test computer 6 is used to send a test command to the SUT 4 through the analyzer 5, perform a test on the SUT 4 according to the test command, collect test results of the SUT 4, and send the collected test results to the analyzer 5. The analyzer 5 generates an initial test report of the SUT 4 according to the collected rest results, and sends the initial test report to the control computer 2 through the switch 3. The control computer 2 processes the initial test report to generate an optimized test report relating to the SUT 4. In one embodiment, the test computer 6 performs the test on the SUT 4 using an input/output (I/O) testing software (e.g., an Iometer tool) to test an I/O speed of the SUT 4. It may be understood that, in other embodiments, the test computer 6 can be removed by incorporating the functions of the test computer 6 into the control computer 2.

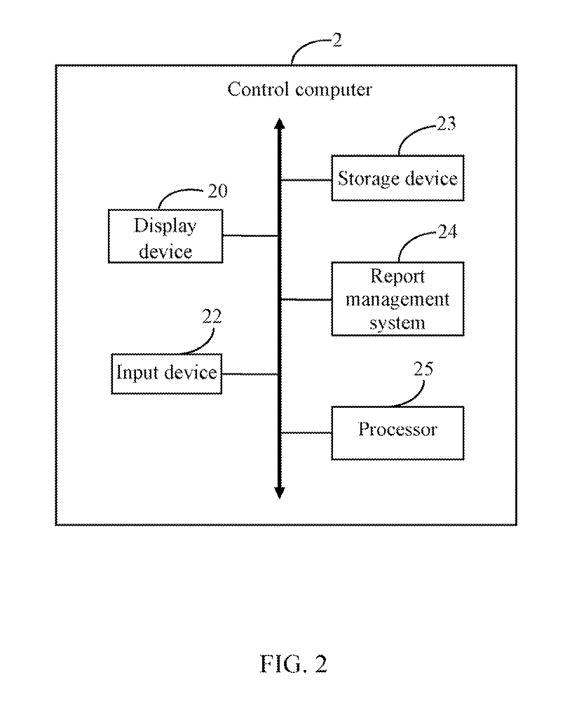

FIG. 2 is a block diagram of one embodiment of the control computer 2. In one embodiment, the control computer 2 includes a display device 20, an input device 22, a storage device 23, a report management system 24, and at least one processor 25. The report management system 24 may be used to add error causes and solutions for error logs in the initial test report of the SUT 4, to generate an optimized test report relating to the SUT 4.

The display device 20 may be used to display the initial test report and the optimized test report of the SUT 4, and the input device 22 may be a mouse or a keyboard used to input computer readable data.

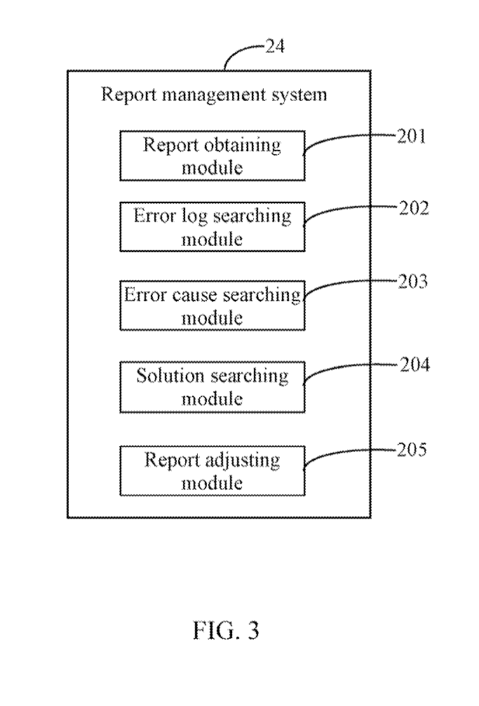

FIG. 3 is a block diagram of one embodiment of the report management system 24 in the control computer 2. In one embodiment, the report management system 24 may include one or more modules, for example, a report obtaining module 201, an error log searching module 202, an error cause searching module 203, a solution searching module 204, and a report adjusting module 205. The one or more modules 201-205 may comprise computerized code in the form of one or more programs that are stored in the storage device 23 (or memory). The computerized code includes instructions that are executed by the at least one processor 25 to provide functions for the one or more modules 201-205.

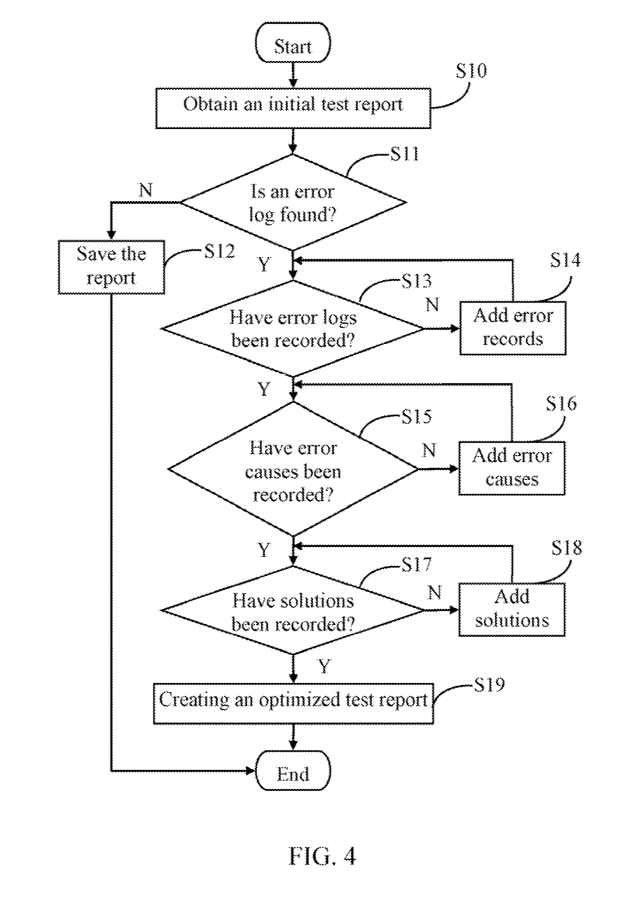

FIG. 4 is a flowchart of one embodiment of a method for managing test reports of the SUT 4 using the control computer 2. Depending on the embodiment, additional blocks may be added, others removed, and the ordering of the blocks may be changed.

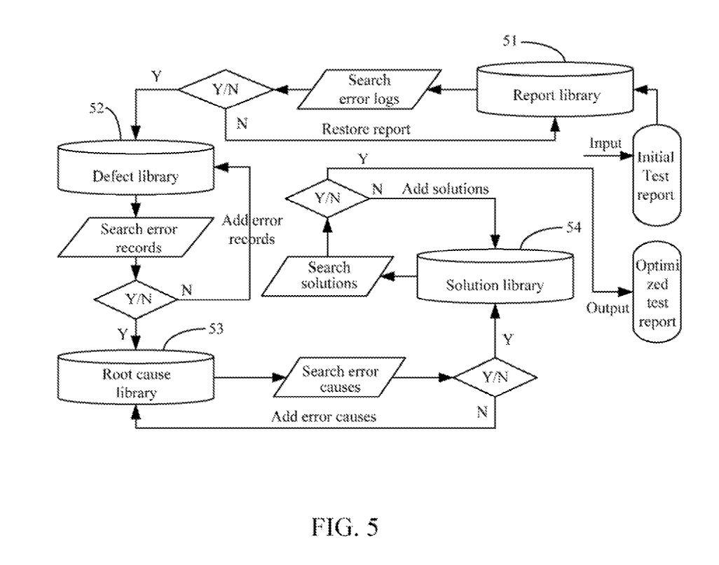

In block S10, the report obtaining module 201 obtains an initial test report of the SUT 4 from a report library 51 (as shown in FIG. 5) of the storage device 23.

In block S11, the error log searching module 202 searches for an error log in the initial test report, and determines if at least one error log has been found in the initial test report. If one or more error logs have been found in the initial test report, the procedure goes to block S13. If no error log has been found in the initial test report, the procedure goes to block S12. In one embodiment, each error log records the failure of a test item of the SUT 4 in the initial test report. The initial test report includes a field flag to record a test result for each test item of the SUT 4, for example, the field flag is preset as a first value (e.g., 1) for a passed test item of the SUT, or preset as a second value (e.g., 0) for a failed test item of the SUT.

In block S12, the error log searching module 202 saves the initial test report into the report library 51, and the procedure ends. The report library 51 is defined as a collection of libraries containing text that record the test reports for the test items of the SUT 4.

In block S13, the error log searching module 202 determines if any error logs which have been found have been recorded in a defect library 52 (as shown in FIG. 5) of the storage device 23. The defect library 52 is defined as a collection of libraries containing text that record the error logs for the test items of the SUT 4. If any found error logs have not been recorded in the defect library 52, the procedure goes to block S14. If all of the found error logs have been recorded in the defect library 52, the procedure goes to block S15.

In block S14, the error log searching module 202 adds the found error logs into the defect library 52, then the procedure returns to block S13.

In block S15, the error cause searching module 203 determines if error causes of the found error logs have been recorded in a root cause library 53 (as shown in FIG. 5) of the storage device 23. The root cause library 53 is defined as a collection of libraries containing text that record the error causes of the error logs for the test items of the SUT 4. If any of the error causes of the found error logs have not been recorded in the root cause library 53, the procedure goes to block S16. If all of the error causes of the found error logs have been recorded in the root cause library 53, the procedure goes to block S17.

In block S16, the error cause searching module 203 adds the error causes of the found error logs into the root cause library 53, and the procedure returns to block S15. In one embodiment, the error causes of the found error logs may be added into the root cause library 53 manually by a user or automatically obtained from other application systems.

In block S17, the solution searching module 204 determines if solutions of the found error logs have been recorded in a solution library 54 (as shown in FIG. 5) of the storage device 23. The solution library 54 is defined as a collection of libraries containing text that record the solutions of the error logs for the test items of the SUT 4. If any of the solutions of the found error logs have not been recorded in the solution library 54, the procedure goes to block S18. If all of the solutions of the found error logs have been recorded in the solution library 54, the procedure goes to block S19.

In block S18, the solution searching module 204 adds the solutions of the found error logs into the solution library 54, and the procedure returns to block S17. In one embodiment, the error causes of the found error logs may be added into the solution library 54 manually by the user or automatically obtained from other application systems.

In block S19, the report adjusting module 205 adds the error causes and the solutions corresponding to the found error logs in the initial test report, to obtain an optimized test report of the SUT 4, and displays the optimized test report of the SUT 4 on the display device 20 of the control computer 2. Further, the report adjusting module 205 stores the optimized test report in the report library 51 of the storage device 23.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for managing test reports of a system under test (SUT) using a control computer, the method comprising:
obtaining an initial test report of the SUT from a report library of a storage device of the control computer;
searching for an error log in the initial test report, and saving the initial test report into the report library upon the condition that the error log has not been found;
determining if found error logs have been recorded in a defect library of the storage device upon the condition that one or more error logs have been found, and adding the found error logs into the defect library upon the condition that the found error logs have not been recorded in the defect library;
determining if error causes of the found error logs have been recorded in a root cause library of the storage device upon the condition that the found error logs have been recorded in the defect library, and adding the error causes of the found error logs into the root cause library upon the condition that the error causes of the found error logs have not been recorded in the root cause library;
determining if solutions of the found error logs have been recorded in a solution library of the storage device upon the condition that the found error logs have been recorded in the root cause library, and adding the solutions of the found error logs into the solution library upon the condition that the solutions of the found error logs have not been recorded in the solution library;
adding the error causes and the solutions corresponding to the found error logs in the initial test report upon the condition that the found error logs have been recorded in the solution library, and obtaining an optimized test report of the SUT; and
displaying the optimized test report of the SUT on a display device of the control computer.

2. The method according to claim 1, wherein the initial test report is obtained using an analyzer connected with the control computer.

3. The method according to claim 1, wherein each of the error logs records a failed test item of the SUT in the initial test report.

4. The method according to claim 3, wherein the initial test report comprises a field flag to record a test result of each test item of the SUT, the field flag is preset as a first value upon the condition that the test item of the SUT is passed, or preset as a second value upon the condition that the test item of the SUT is failed.

5. The method according to claim 1, further comprising:
storing the optimized test report in the report library of the storage device.

6. A control computer, comprising:
a storage device;
at least one processor; and
one or more modules that are stored in the storage device and are executed by the at least one processor, the one or more modules comprising instructions:
to obtain an initial test report of the SUT from a report library of a storage device of the control computer;
to search for an error log in the initial test report, and save the initial test report into the report library upon the condition that the error log has not been found;
to determine if found error logs have been recorded in a defect library of the storage device upon the condition that one or more error logs have been found, and add the found error logs into the defect library upon the condition that the found error logs have not been recorded in the defect library;
to determine if error causes of the found error logs have been recorded in a root cause library of the storage device upon the condition that the found error logs have been recorded in the defect library, and add the error causes of the found error logs into the root cause library upon the condition that the error causes of the found error logs have not been recorded in the root cause library;
to determine if solutions of the found error logs have been recorded in a solution library of the storage device upon the condition that the found error logs have been recorded in the root cause library, and add the solutions of the found error logs into the solution library upon the condition that the solutions of the found error logs have not been recorded in the solution library;
to add the error causes and the solutions corresponding to the found error logs in the initial test report upon the condition that the found error logs have been recorded in the solution library, and obtain an optimized test report of the SUT; and
to display the optimized test report of the SUT on a display device of the control computer.

7. The control computer according to claim 6, wherein the initial test report is obtained using an analyzer connected with the control computer.

8. The control computer according to claim 6, wherein each of the error logs records a failed test item of the SUT in the initial test report.

9. The control computer according to claim 8, wherein the initial test report comprises a field flag to record a test result of each test item of the SUT, the field flag is preset as a first value upon the condition that the test item of the SUT is passed, or preset as a second value upon the condition that the test item of the SUT is failed.

10. The control computer according to claim 6, wherein the one or more modules further comprises instructions: storing the optimized test report in the report library of the storage device.

11. A non-transitory storage medium having stored thereon instructions that, when executed by a processor of a control computer, causes the processor to perform a method for managing test reports of a system under test, the method comprising:
obtaining an initial test report of the SUT from a report library of a storage device of the control computer;
searching for an error log in the initial test report, and saving the initial test report into the report library upon the condition that the error log has not been found;
determining if found error logs have been recorded in a defect library of the storage device upon the condition that one or more error logs have been found, and adding the found error logs into the defect library upon the condition that the found error logs have not been recorded in the defect library;
determining if error causes of the found error logs have been recorded in a root cause library of the storage device upon the condition that the found error logs have been recorded in the defect library, and adding the error causes of the found error logs into the root cause library upon the condition that the error causes of the found error logs have not been recorded in the root cause library;
determining if solutions of the found error logs have been recorded in a solution library of the storage device upon the condition that the found error logs have been recorded in the root cause library, and adding the solutions of the found error logs into the solution library upon the condition that the solutions of the found error logs have not been recorded in the solution library;
adding the error causes and the solutions corresponding to the found error logs in the initial test report upon the condition that the found error logs have been recorded in the solution library, and obtaining an optimized test report of the SUT; and
displaying the optimized test report of the SUT on a display device of the control computer.

12. The non-transitory storage medium according to claim 11, wherein the initial test report is obtained using an analyzer connected with the control computer.

13. The non-transitory storage medium according to claim 11, wherein each of the error logs records a failed test item of the SUT in the initial test report.

14. The non-transitory storage medium according to claim 13, wherein the initial test report comprises a field flag to record a test result of each test item of the SUT, the field flag is preset as a first value upon the condition that the test item of the SUT is passed, or preset as a second value upon the condition that the test item of the SUT is failed.

15. The non-transitory storage medium according to claim 11, wherein the method further comprises: storing the optimized test report in the report library of the storage device.

16. The non-transitory storage medium according to claim 11, wherein the medium is selected from the group consisting of a hard disk drive, a compact disc, a digital video disc, and a tape drive.
